(19) United States
(12) Patent Application Publication
(10) Pub. No.: US 2024/0169123 A1
(43) Pub. Date: May 23, 2024

(54) INFORMATION PROCESSING APPARATUS, INFORMATION PROCESSING METHOD, AND STORAGE MEDIUM THEREOF

(71) Applicant: Tokyo Electron Limited, Tokyo (JP)

(72) Inventors: Tatsuya YAMAGUCHI, Tokyo (JP); Ryosuke SHIBATSUJI, Iwate (JP)

(21) Appl. No.: 18/512,477

(22) Filed: Nov. 17, 2023

(30) Foreign Application Priority Data
Nov. 22, 2022 (JP) 2022-186439

(51) Int. Cl. G06F 30/20

(52) U.S. Cl. CPC G06F 30/20

(57) ABSTRACT

An information processing apparatus includes a simulation execution unit that executes a simulation using a simulation model of a substrate processing apparatus according to a process parameter, a disturbance generation unit that generates a disturbance indicating a temperature change in the substrate processing apparatus according to the process parameter, and a temperature adjustment unit that adjusts a temperature calculated by the simulation model based on the disturbance.

### CROSS-REFERENCE TO RELATED APPLICATIONS

The present application is based on and claims priority from Japanese Patent Application No. 2022-186439, filed on Nov. 22, 2022, with the Japan Patent Office, the disclosure of which is incorporated herein in its entirety by reference.

### TECHNICAL FIELD

The present disclosure relates to an information processing apparatus, an information processing method, and a storage medium that stores a program.

### BACKGROUND

In the field of semiconductor product manufacture or research and development, process simulation is used. Process simulation allows various physical phenomena related to semiconductor processes to be handled through physical models (see, e.g., Japanese Patent Application Laid-open No. 2018-125451). For example, in a process simulation, the process state during the execution of a semiconductor process is estimated from measurement results obtained after the semiconductor process has been executed.

### SUMMARY

According to one aspect of the present disclosure, there is provided an information processing apparatus including a simulation execution unit that executes a simulation using a simulation model of a substrate processing apparatus according to a process parameter, a disturbance generation unit that generates a disturbance indicating a temperature change in the substrate processing apparatus according to the process parameter, and a temperature adjustment unit that adjusts a temperature calculated by the simulation model based on the disturbance.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram illustrating an example of temperature settings in a process recipe.

FIG. 2 is a block diagram illustrating an example of an overall configuration of an information processing system.

FIG. 3 is a schematic cross-sectional diagram illustrating an example of a substrate processing apparatus.

FIG. 4 is a block diagram illustrating an example of a hardware configuration of a computer.

FIG. 5 is a block diagram illustrating an example of a functional configuration of an analysis device.

FIG. 6 is a flowchart illustrating an example of a generation processing.

FIG. 7 is a diagram illustrating an example of disturbance to the furnace temperature.

FIG. 8 is a diagram illustrating an example of disturbance to the wafer temperature.

FIG. 9 is a diagram illustrating an example of disturbance parameters.

FIG. 10 is a flowchart illustrating an example of an execution processing.

FIG. 11 is a diagram illustrating an example of a simulation screen.

FIGS. 12A and 12B are diagrams illustrating an example of simulation results for furnace temperature.

FIGS. 13A and 13B are diagrams illustrating an example of simulation results for wafer temperature.

FIGS. 14A and 14B are diagrams illustrating an example of simulation results for heater power.

### DETAILED DESCRIPTION

In the following detailed description, reference is made to the accompanying drawings, which form a part thereof. The illustrative embodiments described in the detailed description, drawings, and claims are not meant to be limiting. Other embodiments may be utilized, and other changes may be made without departing from the spirit or scope of the subject matter presented here.

Hereinafter, embodiments for carrying out the present disclosure will be described with reference to the drawings. In each drawing, the same reference numerals may be given to the same components, and redundant descriptions may be omitted.

### Embodiment

One embodiment of the present disclosure is an information processing system for performing a simulation related to temperature control in a substrate processing apparatus. In the present embodiment, an example of the substrate processing apparatus is a vertical thermal processing apparatus. In the present embodiment, the simulation involves estimating a temperature state in the substrate processing apparatus during the execution of a semiconductor process according to process parameters.

In the present embodiment, a simulation target is temperature control related to the temperature inside a processing container of the vertical thermal processing apparatus (hereinafter also referred to as “furnace temperature”) and the temperature of a semiconductor wafer (hereinafter also referred to as “wafer temperature”), which is an example of a processing target of the vertical thermal processing apparatus. However, temperature control in the present embodiment is not limited to these temperatures and may be any temperature as long as it may be measured inside the substrate processing apparatus.

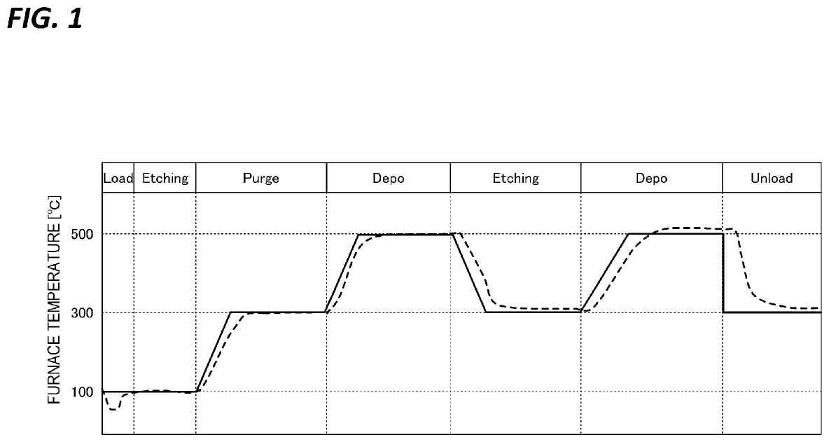

In the vertical thermal processing apparatus, temperature control is crucial when executing a semiconductor process such as a film forming process. FIG. 1 is a diagram illustrating an example of temperature settings in a process recipe. The solid line represents the transition of the set temperature. The dashed line represents the transition of the furnace temperature.

As illustrated in FIG. 1, the temperature setting in the process executed by the vertical thermal processing apparatus is complicated, and the set temperature may be changed multiple times within one film forming process. Therefore, when setting a process recipe, it is important to execute a temperature control simulation to verify the validity of the set process recipe.

In particular, in the vertical thermal processing apparatus, there are operations where a temperature state inside the processing container undergoes a significant change. In such operations, an improvement in the accuracy of simulations is challenged since external factors have complex effects. Examples of the operations leading to a significant change in the temperature state include loading a semiconductor wafer into the processing container and unloading a processed semiconductor wafer from the processing container. A further example includes an operation of changing the pressure inside the processing container for the introduction of a processing gas into the container or for the discharge of the gas from the processing container.

### <System Configuration>

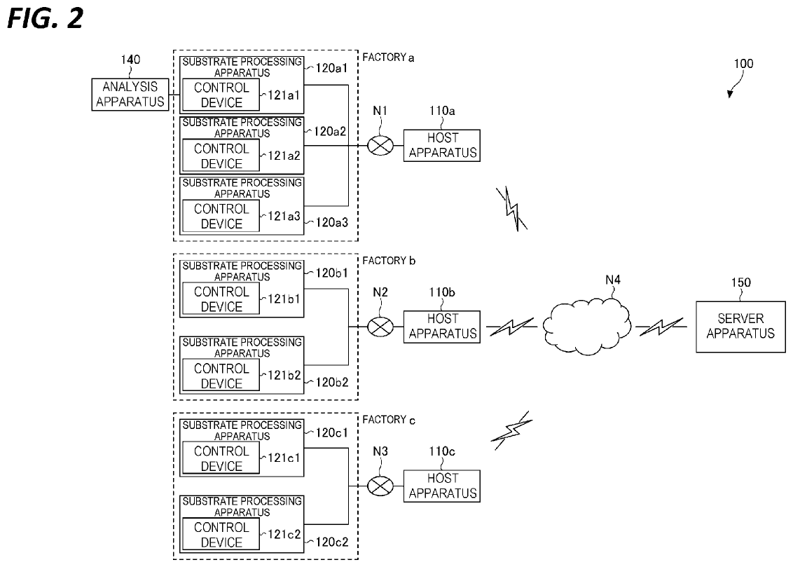

An overall configuration of the information processing system according to the present embodiment will be described with reference to FIG. 2. FIG. 2 is a block diagram illustrating an example of an overall configuration of the information processing system according to the present embodiment.

As illustrated in FIG. 2, the information processing system 100 includes substrate processing apparatuses 120a1 to 120a3 and control devices 121a1 to 121a3 in a factory a. The substrate processing apparatuses 120a1 to 120a3 and the control devices 121a1 to 121a3 are connected in a wired or wireless manner.

Further, the information processing system 100 includes substrate processing apparatuses 120b1 and 120b2 and control devices 121b1 and 121b2 in factory b. The substrate processing apparatuses 120b1 and 120b2 and the control devices 121b1 and 121b2 are connected in a wired or wireless manner.

Further, the information processing system 100 includes substrate processing apparatuses 120c1 and 120c2 and control devices 121c1 and 121c2 in a factory c. The substrate processing apparatuses 120c1 and 120c2 and the control devices 121c1 and 121c2 are connected in a wired or wireless manner.

The substrate processing apparatuses 120a1 to 120a3, substrate processing apparatuses 120b1 and 120b2, and substrate processing apparatuses 120c1 and 120c2 are connected to host apparatuses 110a, 110b and 110c via networks N1 to N3, respectively. Each substrate processing apparatus executes a substrate processing under the control of each control device based on instructions from the host apparatuses 110a, 110b and 110c. The host apparatuses 110a, 110b and 110c are connected to a server apparatus 150 via a network N4 such as the Internet.

In the following description, the substrate processing apparatuses 120a1 to 120a3, 120b1, 120b2, 120c1 and 120c2 are collectively referred to as the substrate processing apparatuses 120. Further, the control devices 121a1 to 121a3, 121b1, 121b2, 121c1 and 121c2 are collectively referred to as the control devices 121. The host apparatuses 110a, 110b and 110c are collectively referred to as the host apparatuses 110.

The substrate processing apparatuses 120a1 to 120a3, substrate processing apparatuses 120b1 and 120b2, and substrate processing apparatuses 120c1 and 120c2 are assumed to accumulate a wide variety of data where they manage individually inside respective devices thereof.

An analysis apparatus 140 is connected to the substrate processing apparatuses 120 including the substrate processing apparatus 120a1, thereby continuously acquiring the accumulated data stored in each substrate processing apparatus 120. The example of FIG. 2 illustrates the connection of the analysis apparatus 140 to the substrate processing apparatus 120a1 but is not limited to this. Hereinafter, in the present embodiment, detailed contents of a case where the analysis apparatus 140 is connected to the substrate processing apparatus 120a1 will be described.

The information processing system 100 illustrated in FIG. 2 is merely an example, and needless to say, there are various other system configuration examples depending on the use or purpose. The categorization of devices such as the substrate processing apparatus 120, control device 121, host apparatus 110, and server apparatus 150 illustrated in FIG. 2 is merely an example. For example, the numbers of substrate processing apparatuses 120, control devices 121, factories, host apparatuses 110, and others are merely an example, but are not limited thereto.

For example, the information processing system 100 may have various configurations, such as a configuration in which at least two of the substrate processing apparatus 120, control device 121, host apparatus 110, and server apparatus 150 are integrated, or a configuration in which they are further divided. For example, the control device 121 may collectively control a plurality of substrate processing apparatuses 120, may be provided in a one to one ratio for each substrate processing apparatus 120, or may be integrated into the substrate processing apparatus 120.

Further, the analysis apparatus 140 has been exemplified as being connected to the substrate processing apparatus 120a1, but the analysis apparatus 140 may be connected to another substrate processing apparatus 120 as well.

The analysis apparatus 140 may be implemented by the host apparatus 110, or may be implemented by the server apparatus 150. In this case, the analysis apparatus 140 becomes unnecessary. Further, the analysis apparatus 140 may be implemented by the control device 121. The analysis apparatus 140 may be implemented by a control device (not illustrated) that collectively controls a plurality of control devices 121.

### <Substrate Processing Apparatus>

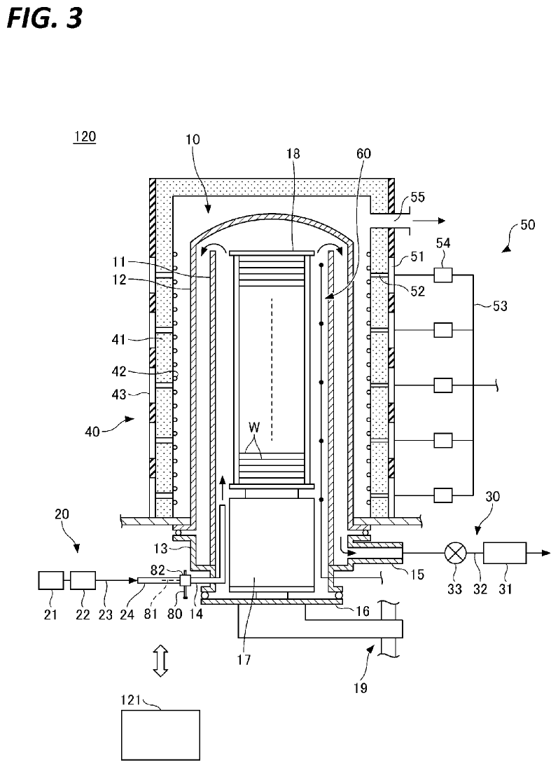

An example of the substrate processing apparatus according to the present embodiment will be described with reference to FIG. 3. FIG. 3 is a schematic cross-sectional diagram illustrating a vertical thermal processing apparatus, which is an example of the substrate processing apparatus according to the present embodiment.

In the present embodiment, the vertical thermal processing apparatus 120 is a substrate processing apparatus that simultaneously accommodates a large number of semiconductor wafers W, which are an example of a processing target, to perform a thermal processing such as oxidation, diffusion, or low-pressure CVD. As illustrated in FIG. 3, the vertical thermal processing apparatus 120 includes a processing container 10, a gas supply unit 20, an exhaust unit 30, a heating unit 40, a cooling unit 50, the control device 121, among others.

The processing container 10 has a substantially cylindrical shape. The processing container 10 includes an inner tube 11, an outer tube 12, a manifold 13, an injector 14, a gas outlet 15, a lid body 16, among others. The inner tube 11 has a substantially cylindrical shape. The outer tube 12 has a ceilinged substantially cylindrical shape. Both the inner tube 11 and the outer tube 12 form a double pipe structure. The inner tube 11 and the outer tube 12 are made of a heat-resistant material such as quartz.

The manifold 13 has a substantially cylindrical shape. The manifold 13 supports lower ends of both the inner tube 11 and the outer tube 12. The manifold 13 is made of, for example, stainless steel. The injector 14 passes through the manifold 13 to extend horizontally inside the inner tube 11 and is bent into an L-shape inside the inner tube 11 to extend upward. The injector 14 has a base connected to a gas introduction pipe 24 and an open tip. The injector 14 is used to discharge a processing gas (hereinafter simply referred to as “gas”) introduced through the gas introduction pipe 24 into the inner tube 11 from an opening at the tip thereof. There may be a plurality of injectors 14.

The gas outlet 15 is formed in the manifold 13. The processing gas is exhausted through the gas outlet 15 by the exhaust unit 30. The lid body 16 airtightly seals an opening at a lower end of the manifold 13. The lid body 16 is made of, for example, stainless steel. A wafer boat (substrate holder) 18 is disposed above the lid body 16 via a heat reservoir 17. The heat reservoir 17 and wafer boat 18 are made of a heat-resistant material such as quartz.

The wafer boat 18 holds a plurality of semiconductor wafers W approximately horizontally at predetermined interval in the vertical direction. The wafer boat 18 is loaded into the processing container 10 when a lifting mechanism 19 raises the lid body 16, thus being accommodated in the processing container 10. The wafer boat 18 is unloaded from the processing container 10 when the lifting mechanism 19 lowers the lid body 16.

The gas supply unit 20 includes a gas source 21, an integrated gas system (IGS) 22, an external pipe 23, and the gas introduction pipe 24. The gas source 21 is a source of the processing gas and includes, for example, a film forming gas source, a cleaning gas source, and a purge gas source. The IGS 22 is an integrated circuit of gas pipes, where pipe groups connected respectively to the film forming gas source, cleaning gas source, and purge gas source of the gas source 21 are integrated. A flow controller is provided inside the IGS 22 to control the flow rate of a gas flowing through each pipe. The flow controller includes, for example, a mass flow controller and an on/off valve.

The IGS 22 is connected to the external pipe 23. The external pipe 23 is connected to the gas introduction pipe 24. A heater (not illustrated) is wound around the outer periphery of the external pipe 23 to heat the external pipe 23. The gas introduction pipe 24 is connected to the processing container 10 to introduce the gas to the inside of the processing container 10. That is, the processing gas from the gas source 21 is controlled for the flow rate thereof by the flow controller inside the IGS 22, and is heated while flowing through the external pipe 23 and is then directed into the gas introduction pipe 24, and is finally supplied from the gas introduction pipe 24 into the processing container 10 through the injector 14. The injector 14 functions as a gas inlet of the processing container 10.

A gas pipe joint 82 connected to the gas introduction pipe 24 is provided near the gas inlet of the processing container 10. A temperature sensor 80 is configured to pass through the joint 82. The temperature sensor 80 is configured to measure the temperature of the gas inside the gas introduction pipe 24. The temperature sensor 80 transmits the measured temperature to the control device 121. Further, a second heater 81 is arranged inside the gas introduction pipe 24. The second heater 81 is configured to heat the gas inside the gas introduction pipe 24.

The exhaust unit 30 includes an exhaust device 31, an exhaust pipe 32, and a pressure controller 33. The exhaust device 31 is, for example, a vacuum pump such as a dry pump or turbo molecular pump. The pressure controller 33 is interposed in the exhaust pipe 32 and serves to control the pressure inside the processing container 10 by adjusting the conductance of the exhaust pipe 32. The pressure controller 33 is, for example, an automatic pressure control valve.

The heating unit 40 includes an insulator 41, a first heater 42, and an outer shell 43. The heat insulator 41 has a substantially cylindrical shape and is provided around the outer tube 12. The heat insulator 41 is made of silica and alumina as main components. The first heater 42 has a linear shape and is attached in a spiral or meandering shape to the inner periphery of the heat insulator 41. The first heater 42 is configured to enable temperature control in a plurality of zones divided in the height direction of the processing container 10. The outer shell 43 is attached to cover the outer periphery of the heat insulator 41. The outer shell 43 serves to maintain the shape of the heat insulator 41 and to reinforce the heat insulator 41. The outer shell 43 is made of a metal such as stainless steel. Further, in order to prevent the influence of heat on the exterior of the heating unit 40, a water cooling jacket (not illustrated) may be attached to the outer periphery of the outer shell 43. This heating unit 40 is used to heat the inside of the processing container 10 by generating heat through the first heater 42.

The cooling unit 50 is used to supply a cooling fluid toward the processing container 10 to cool the semiconductor wafer W inside the processing container 10. The cooling fluid may be, for example, air. The cooling unit 50 supplies the cooling fluid toward the processing container 10, for example, when rapidly cooling the semiconductor wafer W after a thermal processing. The cooling unit 50 includes a fluid flow path 51, a jet hole 52, a distribution flow path 53, a flow adjuster 54, and a heat discharge port 55.

A plurality of fluid flow paths 51 are formed in the height direction between the heat insulator 41 and the outer shell 43. The fluid flow paths 51 are, for example, flow paths formed in the circumferential direction outside the heat insulator 41. The jet hole 52 is formed to pass through the heat insulator 41 from each fluid flow path 51 and serves to spout the cooling fluid into a space between the outer tube 12 and the heat insulator 41. The distribution flow path 53 is provided outside the outer shell 43 and serves to distribute and supply the cooling fluid to each fluid flow path 51. The flow adjuster 54 is interposed in the distribution flow path 53 and serves to adjust the flow rate of the cooling fluid supplied to the fluid flow path 51.

The heat discharge port 55 is provided above a plurality of jet holes 52 and serves to discharge the cooling fluid supplied to the space between the outer tube 12 and the heat insulator 41 to the outside of the processing container 10. The cooling fluid discharged to the outside of the processing container 10 is cooled by, for example, a heat exchanger and is supplied back to the distribution flow path 53. However, the cooling fluid discharged to the outside of the processing container 10 may be discharged without being reused.

A temperature sensor 60 is used to detect the temperature inside the processing container 10. The temperature sensor 60 is provided, for example, inside the inner tube 11. However, the temperature sensor 60 may be provided at any position where it may detect the temperature inside the processing container 10. For example, the temperature sensor 60 may be provided in a space between the inner tube 11 and the outer tube 12. The temperature sensor 60 includes, for example, a plurality of temperature measuring parts provided at different positions in the height direction corresponding to a plurality of zones. The temperature measuring parts of the temperature sensor 60 are provided to correspond to zones “BTM,” “CTR-1,” “CTR-2,” “CTR-3,” and “TOP,” respectively, in order from the bottom. FIG. 3 illustrates an example in which the inside of the processing container is divided into five zones, but the number of zones may be designed arbitrarily. The plurality of temperature measuring parts may be, for example, thermocouples or temperature measuring resistors. The temperature sensor 60 transmits temperatures detected by the plurality of temperature measuring parts to the control device 121.

The control device 121 controls an operation of the vertical thermal processing apparatus 120, thereby controlling semiconductor processes executed by the vertical thermal processing apparatus 120. The control device 121 may be, for example, a computer.

### <Hardware Configuration>

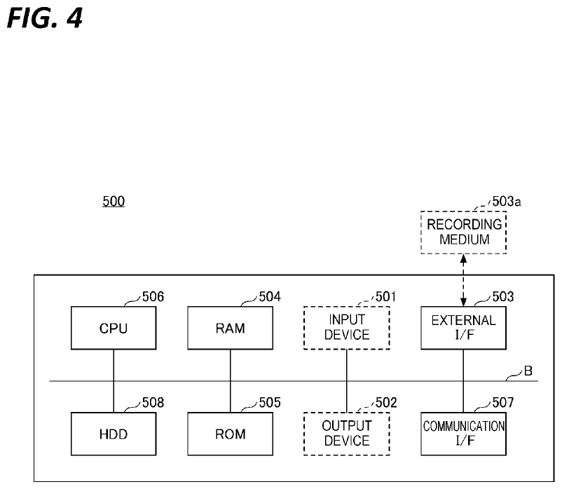

The host apparatus 110, control device 121, analysis apparatus 140, and server apparatus 150 included in the information processing system 100 illustrated in FIG. 2 are implemented by, for example, a computer having a hardware configuration as illustrated in FIG. 4. FIG. 4 is a block diagram illustrating an example of a hardware configuration of a computer according to the present embodiment.

As illustrated in FIG. 4, a computer 500 according to the present embodiment includes an input device 501, an output device 502, an external interface (I/F) 503, a random access memory (RAM) 504, a read only memory (ROM) 505, a central processing unit (CPU) 506, a communication I/F 507, and a hard disk drive (HDD) 508, among others, and these respective components are connected to each other via a bus B. The input device 501 and the output device 502 may be connected and used as needed.

The input device 501 is, for example, a keyboard, a mouse, or a touch panel, and is used by an operator or others to input each operation signal. The output device 502 is, for example, a display and is used to display processing results generated by the computer 500. The communication I/F 507 is an interface that connects the computer 500 to a network. The HDD 508 is an example of a non-volatile storage device used to store programs and data.

The external I/F 503 is an interface for an external device. The computer 500 may read from and/or write to a recording medium 503a such as a secure digital (SD) memory card via the external I/F 503. The ROM 505 is an example of a non-volatile semiconductor memory (storage device) in which programs and data are stored. The RAM 504 is an example of a volatile semiconductor memory (storage device) used to temporarily hold programs and data.

The CPU 506 is an arithmetic unit that reads programs and data from storage devices such as the ROM 505 and the HDD 508 onto the RAM 504 and executes a processing to realize the overall control and functions of the computer 500.

### <Functional Configuration>

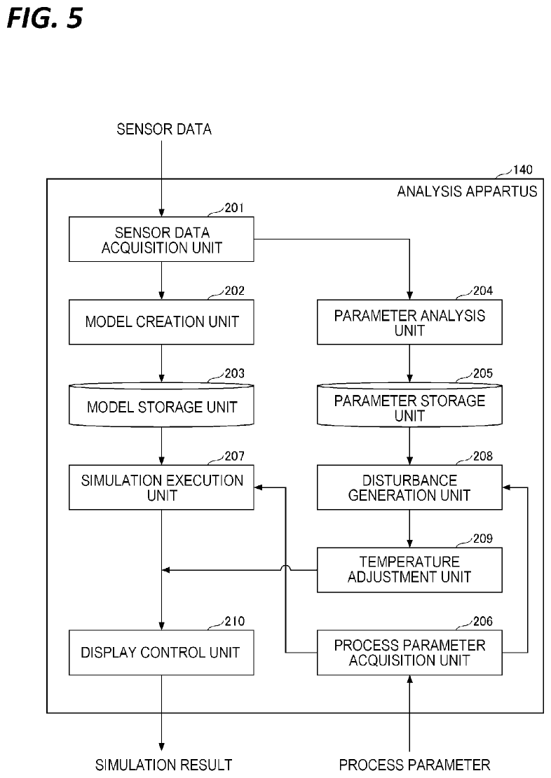

A functional configuration of the analysis device according to the present embodiment will be described with reference to FIG. 5. FIG. 5 is a diagram illustrating an example of a functional configuration of the analysis device according to the present embodiment.

As illustrated in FIG. 5, in the present embodiment, the analysis apparatus 140 includes a sensor data acquisition unit 201, a model creation unit 202, a model storage unit 203, a parameter analysis unit 204, a parameter storage unit 205, a process parameter acquisition unit 206, a simulation execution unit 207, a disturbance generation unit 208, a temperature adjustment unit 209, and a display control unit 210.

The sensor data acquisition unit 201, model creation unit 202, parameter analysis unit 204, process parameter acquisition unit 206, simulation execution unit 207, disturbance generation unit 208, temperature adjustment unit 209, and display control unit 210 are implemented by, for example, the CPU 506 illustrated in FIG. 4 executing a program loaded on the RAM 504. The model storage unit 203 and parameter storage unit 205 are implemented by, for example, the RAM 504 or HDD 508 illustrated in FIG. 4.

The sensor data acquisition unit 201 acquires temperature data and heater power accumulated in the control device 121. The temperature data acquired by the sensor data acquisition unit 201 includes the temperature inside the processing container 10 (furnace temperature) and the temperature of the semiconductor wafer W (wafer temperature). The heater power acquired by the sensor data acquisition unit 201 is power input to the first heater 42. The furnace temperature is detected by, for example, the temperature sensor 60 of the substrate processing apparatus 120. For example, the wafer temperature may be detected using a temperature measurement device disclosed in Japanese Patent Laid-Open Publication No. 2011-128081, or may be estimated using a profile temperature sensor and a temperature estimator disclosed in Japanese Patent Laid-Open Publication No. 2012-209517.

The temperature data acquired by the sensor data acquisition unit 201 is associated with process parameters of a semiconductor process that was executed when the furnace temperature and wafer temperature were detected or estimated. Further, the temperature data includes temperature data measured when an operation with a significant change in the furnace temperature was performed. In the present embodiment, it is assumed that the temperature data includes the furnace temperature and wafer temperature measured when the wafer boat 18 was loaded into the processing container 10.

The model creation unit 202 creates a simulation model that estimates a process state of the substrate processing apparatus 120 based on the temperature data and heater power acquired by the sensor data acquisition unit 201. In the present embodiment, the simulation model is a model that executes a simulation related to temperature control in the substrate processing apparatus 120.

The simulation related to temperature control may be executed using, for example, a mathematical model disclosed in Japanese Patent Laid-Open Publication No. 2013-161857. However, in the present embodiment, the simulation model is not limited to the mathematical model disclosed in Japanese Patent Laid-Open Publication No. 2013-161857, and may be any model as long as it is capable of executing the simulation related to temperature control in the substrate processing apparatus 120.

The model storage unit 203 stores the simulation model created by the model creation unit 202. The model storage unit 203 may store other simulation models for estimating the process state in the substrate processing apparatus 120.

The parameter analysis unit 204 analyzes a first disturbance parameter that indicates the shape of disturbance to the furnace temperature based on the furnace temperature acquired by the sensor data acquisition unit 201. The parameter analysis unit 204 analyzes a second disturbance parameter that indicates the shape of disturbance to the wafer temperature based on the wafer temperature acquired by the sensor data acquisition unit 201.

The parameter analysis unit 204 generates the first disturbance parameter and the second disturbance parameter for each category based on the process parameters. In the present embodiment, categorization is based on combinations of set temperatures and loading speeds. The set temperature is a target furnace temperature (e.g., in° C.). The loading speed is a speed (e.g., in mm/min) at which the wafer boat 18 is loaded into the processing container 10.

The parameter storage unit 205 stores a parameter table that stores the disturbance parameters analyzed by the parameter analysis unit 204. The parameter table stores the first disturbance parameter and the second disturbance parameter for each category based on the process parameters.

The process parameter acquisition unit 206 acquires the process parameters used for simulations. The acquired process parameters may be input from a user through the input device 501, or may be set in the substrate processing apparatus 120.

The simulation execution unit 207 executes the simulation related to temperature control in the substrate processing apparatus 120 using the simulation model read from the model storage unit 203 according to the process parameters acquired by the process parameter acquisition unit 206.

In the present embodiment, the simulation is used to estimate the furnace temperature and wafer temperature when a semiconductor process was executed according to the process parameters and to estimate the heater power to be input to the first heater 42 so as to bring the furnace temperature or wafer temperature closer to the set temperature set by the process parameters. The simulation execution unit 207 repeats the estimation of the furnace temperature and wafer temperature and the estimation of the heater power, executing the simulation related to temperature control in the substrate processing apparatus 120.

The disturbance generation unit 208 generates disturbance data that indicates a temperature change in the substrate processing apparatus 120 based on the process parameters acquired by the process parameter acquisition unit 206. The disturbance generation unit 208 reads the first disturbance parameter and the second disturbance parameter from the parameter storage unit 205 according to the categorization based on the process parameters. The disturbance generation unit 208 generates first disturbance data for adjusting the furnace temperature using the first disturbance parameter read from the parameter storage unit 205. The disturbance generation unit 208 generates second disturbance data for adjusting the wafer temperature using the second disturbance parameter read from the parameter storage unit 205.

The temperature adjustor 209 adjusts the furnace temperature calculated by the simulation execution unit 207 based on the first disturbance data generated by the disturbance generation unit 208. The temperature adjustor 209 adjusts the wafer temperature calculated by the simulation execution unit 207 based on the second disturbance data generated by the disturbance generation unit 208.

The temperature adjustment unit 209 may adjust the furnace temperature or wafer temperature by adding the disturbance data to the furnace temperature or wafer temperature output from the simulation execution unit 207. The temperature adjustment unit 209 may adjust the furnace temperature or wafer temperature by updating, based on the disturbance data, parameters that the simulation execution unit 207 inputs into the simulation model.

The display control unit 210 outputs simulation results calculated by the simulation execution unit 207 to the output device 502. In the simulation results output by the display control unit 210, the furnace temperature and wafer temperature have been adjusted by the temperature adjustment unit 209.

### <Processing Procedure>

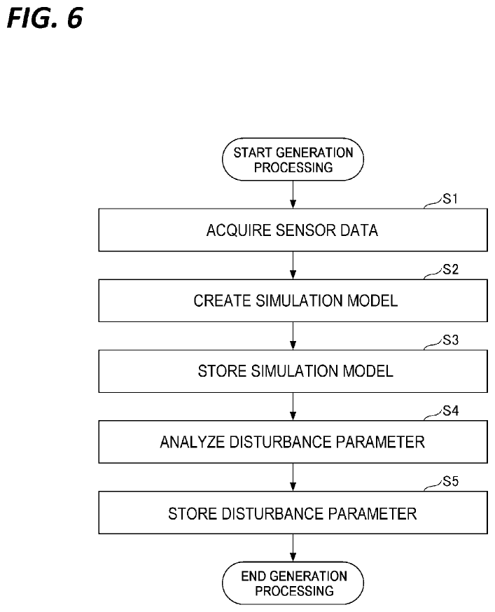

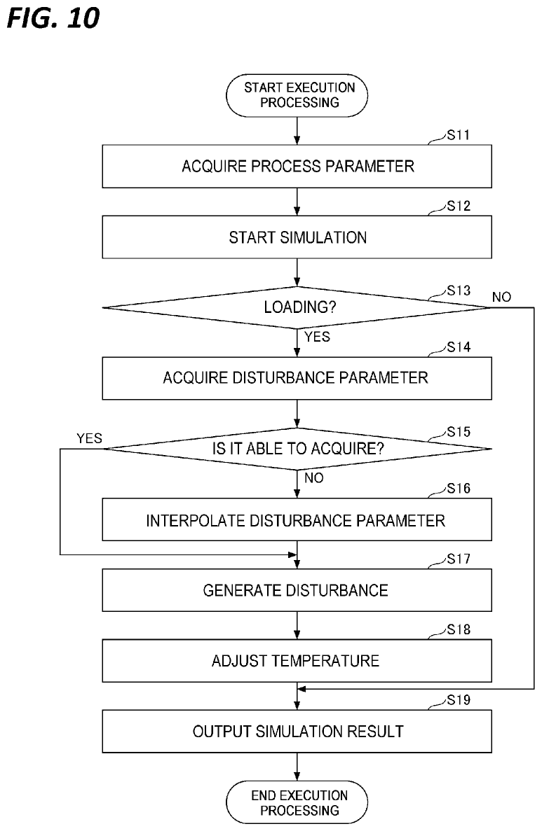

A processing procedure of an information processing method executed by the analysis device according to the present embodiment will be described with reference to FIG. 6. In the present embodiment, the information processing method includes a generation processing (see, e.g., FIG. 6) and an execution processing (see, e.g., FIG. 10).

### «Generation Processing»

FIG. 6 is a flowchart illustrating an example of a generation processing according to the present embodiment. In the generation processing, a simulation model and disturbance parameter used for a simulation are generated based on temperature data collected by the substrate processing apparatus 120.

In step S1, the sensor data acquisition unit 201 of the analysis apparatus 140 sends a request for the acquisition of temperature data and heater power to the control device 121. When receiving the request for the acquisition of temperature data and heater power from the analysis apparatus 140, the control device 121 reads time-series temperature data and heater power stored in a storage such as the HDD 508, and sends them to the analysis apparatus 140. The temperature data includes furnace temperature and wafer temperature detected at a predetermined time interval. Further, the temperature data is associated with process parameters.

The sensor data acquisition unit 201 receives the temperature data and heater power from the control device 121. Next, the sensor data acquisition unit 201 sends the received temperature data and heater power to the model creation unit 202 and the parameter analysis unit 204.

In step S2, the model creation unit 202 of the analysis apparatus 140 receives the temperature data from the sensor data acquisition unit 201. Next, the model creation unit 202 creates a simulation model based on the received temperature data and heater power.

In step S3, the model creation unit 202 of the analysis apparatus 140 stores the simulation model created in step S2 in the model storage unit 203. When an existing simulation model is stored in the model storage unit 203, the model creation unit 202 updates the existing simulation model with the newly created simulation model.

In step S4, the parameter analysis unit 204 of the analysis apparatus 140 receives the temperature data from the sensor data acquisition unit 201. Next, the parameter analysis unit 204 analyzes the first disturbance parameter that indicates the shape of disturbance to the furnace temperature based on the furnace temperature included in the received temperature data. Further, the parameter analysis unit 204 analyzes the second disturbance parameter that indicates the shape of disturbance to the wafer temperature based on the wafer temperature included in the received temperature data.

### (Disturbance Parameter of Furnace Temperature)

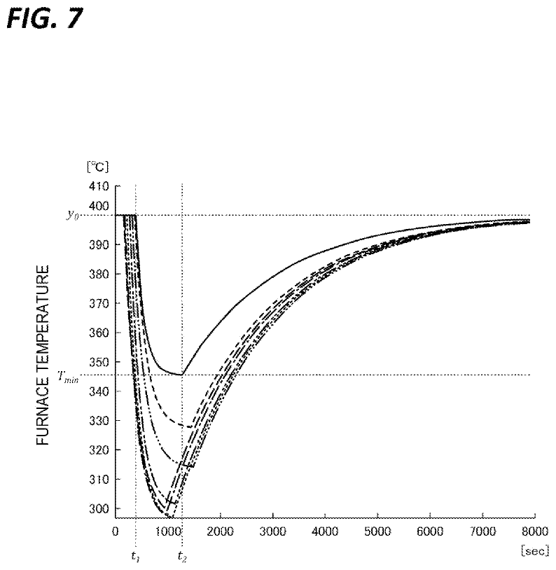

A disturbance parameter of the furnace temperature according to the present embodiment will be described with reference to FIG. 7. FIG. 7 is a diagram illustrating an example of disturbance to the furnace temperature according to the present embodiment.

FIG. 7 is a graph that approximates a furnace temperature change during loading as a discontinuous function with first-order delay curves for both a temperature increase and a temperature decrease. FIG. 7 illustrates a furnace temperature change detected by the temperature measuring part corresponding to each zone. In FIG. 7, the solid line represents a furnace temperature change in the zone TOP at the highest position inside the processing container 10.

The first-order delay curve during the temperature decrease (hereinafter also referred to as “first first-order delay curve”) is represented by Equation (1):

$$y = {y}_{0} + ( {T}_{min} - {y}_{0} ) \times ( 1 - {e}^{- \frac{t - {t}_{1}}{{τ}_{1}}} ) \qquad ( 1 )$$

Here, y₀ is the initial temperature, t₁ is the time when the temperature begins to decrease, Tₘᵢₙ is the minimum temperature when the temperature decrease has ended, and t₁ is the time constant during the temperature decrease.

Among these, the initial temperature y₀ is a target furnace temperature set by the process parameters. Further, the time constant τ₁ is a variable that does not depend on the process parameters. In other words, a temperature change when the furnace temperature decreases from the initial temperature during loading may be represented by a first-order delay curve determined by the start time t₁ and the minimum temperature Tₘᵢₙ.

The first-order delay curve during the temperature increase (hereinafter also referred to as “second first-order delay curve”) is represented by Equation (2):

$$y = {T}_{min} + ( {y}_{0} - {T}_{min} ) \times ( 1 - {e}^{- \frac{t - {t}_{2}}{{τ}_{2}}} ) \qquad ( 2 )$$

Here, y₀ is the initial temperature, t₂ is the end time when the temperature decrease ends, Tₘᵢₙ is the minimum temperature when the temperature decrease has ended, and τ₂ is the time constant during the temperature increase.

Among these, the initial temperature y₀ is a target furnace temperature set by the process parameters. Further, the time constant τ₂ is a variable that does not depend on the process parameters. In other words, a temperature change when the furnace temperature increases from the minimum temperature during loading may be represented by a first-order delay curve determined by the end time t₂ and the minimum temperature Tₘᵢₙ.

The furnace temperature change during loading is a curve obtained by connecting the first first-order delay curve and the second first-order delay curve at the end time t₂ of the temperature decrease. Therefore, the furnace temperature change during loading may be calculated by the start time t₁ when the temperature begins to decrease, the end time t₂ when the temperature decrease ends, and the minimum temperature Tₘᵢₙ when the temperature decrease has ended. Thus, the start time t₁, the end time t₂ and the minimum temperature Tₘᵢₙ become disturbance parameters (first disturbance parameters) of the furnace temperature.

### (Disturbance Parameter of Wafer Temperature)

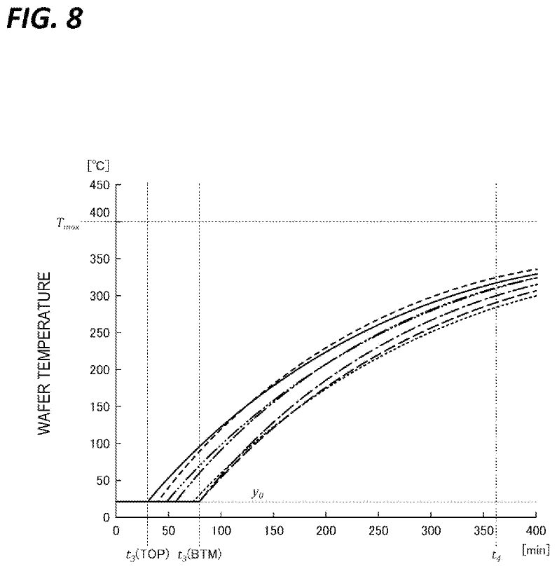

Disturbance parameters of the wafer temperature according to the present embodiment will be described with reference to FIG. 8. FIG. 8 is a diagram illustrating an example of disturbance to the wafer temperature according to the present embodiment.

FIG. 8 a graph that approximates a wafer temperature change during loading as a first-order delay curve. FIG. 8 illustrates a wafer temperature change corresponding to each zone. In FIG. 8, the solid line represents a wafer temperature change in the zone TOP.

The first-order delay curve (hereinafter also referred to as “third first-order delay curve”) is represented by Equation (3):

$$γ = {y}_{0} + ( {T}_{max} - {y}_{0} ) \times ( 1 - {e}^{- \frac{t - {t}_{s}}{τ}} ) \qquad ( 3 )$$

Here, y₀ is the initial temperature, t₃ is the time when the temperature begins to increase, Tₘₐₓ is a target furnace temperature, and τ is the time constant during the temperature increase. In FIG. 8, t₃(TOP) is the time when the temperature in the zone TOP begins to increase, t₃(BTM) is the time when the temperature in the zone BTM begins to increase, and t₄ is the time when loading ends.

Among these, the initial temperature y₀ may be considered equivalent to the room temperature of a space where the substrate processing apparatus 120 is installed. Since the room temperature in a clean room is generally maintained constant, the initial temperature y₀ does not depend on the process parameters. Therefore, a wafer temperature change during loading may be represented by a first-order delay curve determined by the start time t₃ and the time constant t. Thus, the start time t₃ and the time constant t are disturbance parameters (second disturbance parameters) of the wafer temperature.

The parameter analysis unit 204 analyzes the first disturbance parameter and the second disturbance parameter for each combination of the set temperature and loading speed. The parameter analysis unit 204 may analyze each disturbance parameter for each zone inside the processing container 10 for each combination of the set temperature and loading speed. Alternatively, the parameter analysis unit 204 may analyze each disturbance parameter for each arrangement position of the semiconductor wafer W inside the processing container 10 for each combination of the set temperature and loading speed. When analyzing the disturbance parameter for each zone or each arrangement position, the parameter analysis unit 204 may analyze disturbance parameters for a few representative positions (e.g., the zones TOP and BTM) and generate disturbance parameters for other points by interpolation.

Descriptions will be made by referring back to FIG. 6. In step S5, the parameter analysis unit 204 of the analysis apparatus 140 stores the first and second disturbance parameters analyzed in step S4 in the parameter storage unit 205. When existing disturbance parameters are stored in the parameter storage unit 205, the existing disturbance parameters are updated with the newly analyzed disturbance parameters.

### (Method of Storing Disturbance Parameters)

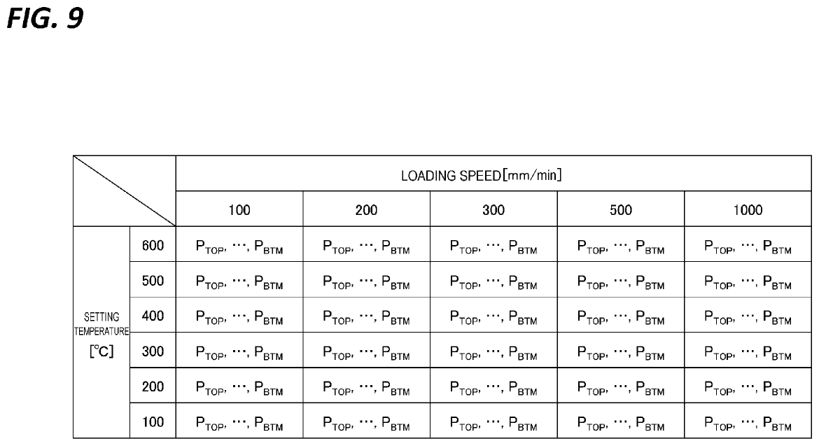

A method of storing disturbance parameters according to the present embodiment will be described with reference to FIG. 9. FIG. 9 is a diagram illustrating an example of disturbance parameters according to the present embodiment.

As illustrated in FIG. 9, disturbance parameters are stored in a parameter table in the parameter storage unit 205 for each combination of the set temperature and loading speed. The disturbance parameters are stored for each zone inside the processing container 10 for the combination of the set temperature and loading speed. P_{TOP}, . . . , P_{BTM} illustrated in FIG. 9 represent disturbance parameters for each zone TOP, . . . , BTM. Each of P_{TOP}, . . . , P_{BTM} includes both the first disturbance parameters t₁, t₂ and Tₘᵢₙ and the second disturbance parameter t₃ and τ. The disturbance parameters may be stored for each arrangement position of the semiconductor wafer W inside the processing container 10 for the combination of the set temperature and loading speed.

### «Execution Processing»

FIG. 10 is a flowchart illustrating an example of an execution processing according to the present embodiment. In the execution processing, a simulation related to temperature control of the substrate processing apparatus 120 is executed using the simulation model and disturbance parameters generated in the generation processing.

In step S11, the process parameter acquisition unit 206 of the analysis apparatus 140 acquires process parameters used for a simulation. For example, the process parameter acquisition unit 206 acquires process parameters received by the input device 501 according to a user input to a simulation screen. Next, the process parameter acquisition unit 206 sends the acquired process parameters to the simulation execution unit 207 and the disturbance generation unit 208.

### (Simulation Screen)

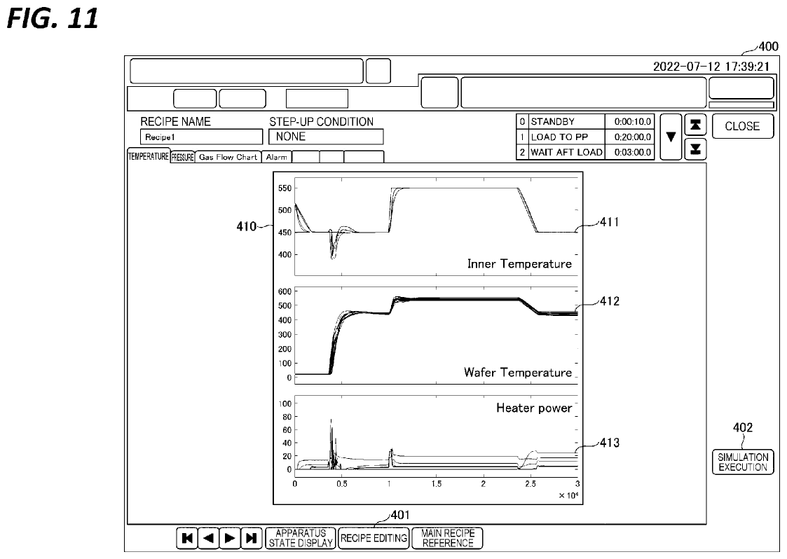

A simulation screen according to the present embodiment will be described with reference to FIG. 11. FIG. 11 is a diagram illustrating an example of a simulation screen according to the present embodiment.

As illustrated in FIG. 11, in the present embodiment, the simulation screen 400 has a recipe editing button 401 and a simulation start button 402. When the user presses the recipe editing button 401, a screen for editing a process recipe is displayed. When the user edits the process recipe on the screen and presses the simulation start button 402, process parameters are acquired from the edited process recipe.

Descriptions will be made by referring back to FIG. 10. In step S12, the simulation execution unit 207 of the analysis apparatus 140 receives the process parameters from the process parameter acquisition unit 206. Next, the simulation execution unit 207 reads the simulation model from the model storage unit 203. Next, the simulation execution unit 207 sets the process parameters in the simulation model and starts the execution of a simulation.

In step S13, the disturbance generation unit 208 of the analysis apparatus 140 determines whether or not the simulation that is being executed by the simulation execution unit 207 is in a loading phase. When it is in the loading phase (YES), the disturbance generation unit 208 proceeds to step S14. When it is not in the loading phase (NO), the disturbance generation unit 208 proceeds to step S19.

In step S14, the disturbance generation unit 208 of the analysis apparatus 140 receives the process parameters from the process parameter acquisition unit 206. Next, the disturbance generation unit 208 reads the first disturbance parameter and the second disturbance parameter from the parameter storage unit 205 based on the combination of the set temperature and loading speed included in the process parameters.

In step S15, the disturbance generation unit 208 of the analysis apparatus 140 determines whether or not it was able to acquire the disturbance parameters in step S14. A case where it is unable to acquire the disturbance parameters is, for example, a case where the set temperature or loading speed in the process parameters acquired in step S11 does not match the combination of the set temperature and loading speed stored in the parameter table. When it was able to acquire the disturbance parameters (YES), the disturbance generation unit 208 proceeds to step S17. When it was not able to acquire the disturbance parameters (NO), the disturbance generation unit 208 proceeds to step S16.

In step S16, the disturbance generation unit 208 of the analysis apparatus 140 generates, by interpolation, a disturbance parameter corresponding to the combination of the set temperature and loading speed included in the process parameters acquired in step S11. The disturbance generation unit 208 may generate the disturbance parameter by interpolation in cases where the disturbance parameter corresponding to the set temperature is not stored in the parameter table, where the disturbance parameter corresponding to the loading speed is not stored in the parameter table, or where the disturbance parameters corresponding to both the set temperature and the loading speed are not stored in the parameter table.

For example, the parameter table illustrated in FIG. 9 stores disturbance parameters for all combinations of the set temperatures of 100° C., 200° C., 300° C., 400° C., 500° C., and 600° C. and the loading speeds of 100 mm/min, 200 mm/min, 300 mm/min, 500 mm/min, and 1,000 mm/min. At this time, When the set temperature and the loading speed included in the process parameters are 350 ° C. and 200 mm/min, no disturbance parameters may be acquired from the parameter table. In this case, the disturbance parameter for the set temperature of 350 ° C. and the loading speed of 200 mm/min may be calculated by reading the disturbance parameters for combinations of the loading speed of 200 mm/min and the set temperatures of 100° C., 200° C., 300° C., 400° C., 500° C., and 600° C., and interpolating them.

When the loading speed included in the process parameters is not stored in the parameter table, a disturbance parameter thereof may be calculated in the same way. When both the set temperature and the loading speed included in the process parameters are not stored in the parameter table, for example, disturbance parameters may be calculated by interpolating them for each set temperature and further interpolating those calculation results.

In step S17, the disturbance generation unit 208 of the analysis apparatus 140 generates the first disturbance data and the second disturbance data based on the disturbance parameters acquired in step S14 or the disturbance parameters generated in step S16. Next, the disturbance generation unit 208 sends the generated first and second disturbance data to the temperature adjustment unit 209.

In step S18, the temperature adjustment unit 209 of the analysis apparatus 140 receives the first disturbance data and the second disturbance data from the disturbance generation unit 208. Next, the temperature adjustment unit 209 adjusts the furnace temperature included in the simulation results by adding the first disturbance data to the furnace temperature output from the simulation model. Subsequently, the temperature adjustment unit 209 adjusts the wafer temperature included in the simulation results by adding the second disturbance data to the wafer temperature output from the simulation model.

The temperature adjustment unit 209 may adjust the furnace temperature included in the simulation results by adding the first disturbance data to the furnace temperature that the simulation execution unit 207 inputs to the simulation model. Similarly, the temperature adjustment unit 209 may adjust the wafer temperature included in the simulation results by adding the second disturbance data to the wafer temperature that the simulation execution unit 207 inputs to the simulation model.

In step S19, the display control unit 210 of the analysis apparatus 140 receives the simulation results from the simulation execution unit 207. The simulation results received by the display control unit 210 have been adjusted for the furnace temperature and wafer temperature by the temperature adjustment unit 209. Next, the display control unit 210 outputs the received simulation results to the output device 502. The display control unit 210 displays the simulation results on, for example, a simulation screen.

### (Simulation Screen)

In the simulation screen illustrated in FIG. 11, a sub-screen 410 for displaying the simulation results is displayed in a model form. The screen displays a furnace temperature simulation result 411 (Inner Temperature), a wafer temperature simulation result 412 (Wafer Temperature), and a heater power simulation result 413 (Heater power) in a comparable manner.

### <Verification Results>

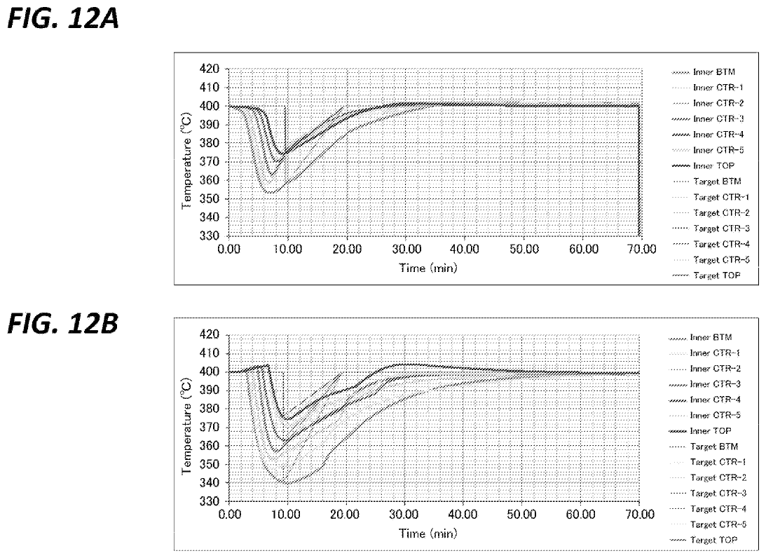

Verification results verifying the accuracy of simulation results by the analysis device according to the present embodiment will be described with reference to FIGS. 12A, 12B, 13A, 13B, 14A, and 14B. In this verification, for the furnace temperature, wafer temperature, and heater power, a process execution through an actual machine and a simulation through the analysis device were executed according to the same process parameters, and the respective results were compared.

In this verification, the process parameters were set to the setting temperature of 400° ° C. and the loading speed of 300 mm/min. Seven zones BTM, CTR-1 to CTR-5 and TOP in order from the bottom were set inside the processing container, and the furnace temperature, wafer temperature, and heater power were compared for each zone.

FIGS. 12A and 12B are diagrams illustrating an example of verification results related to the furnace temperature. FIG. 12A is a graph illustrating the transition of the actual furnace temperature measured during process execution in the vertical thermal processing apparatus 120. FIG. 12B is a graph illustrating simulation results of the furnace temperature output by the analysis apparatus 140.

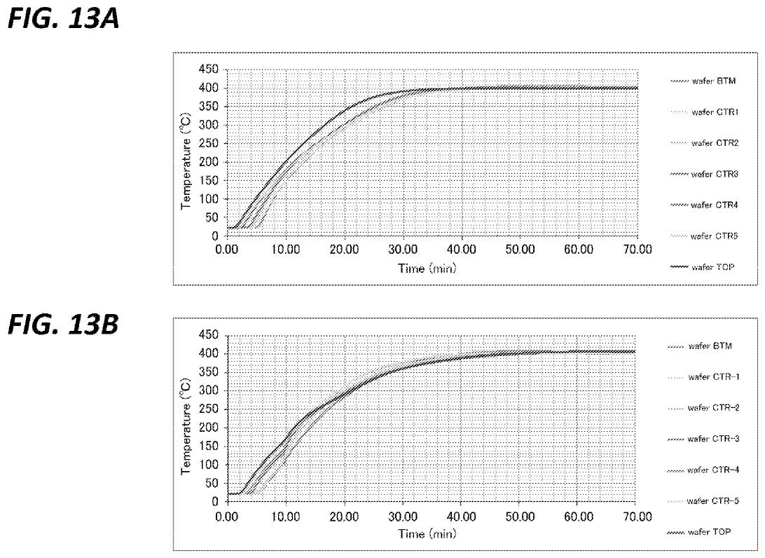

FIGS. 13A and 13B are diagrams illustrating an example of verification results related to the wafer temperature. FIG. 13A is a graph illustrating the transition of the actual wafer temperature measured during process execution in the vertical thermal processing apparatus 120. FIG. 13B is a graph illustrating simulation results of the wafer temperature output by the analysis apparatus 140.

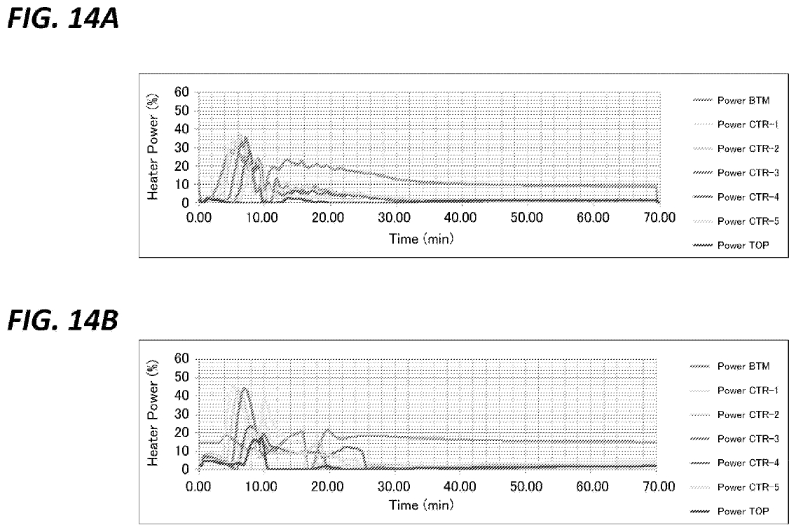

FIGS. 14A and 14B are diagrams illustrating an example of verification results related to heater power. FIG. 14A is a graph illustrating the transition of the actual heater power measured during process execution in the vertical thermal processing apparatus 120. FIG. 14B is a graph illustrating simulation results of the heater power output by the analysis apparatus 140.

As illustrated in FIGS. 12A, 12B, 13A, 13B, 14A and 14B, the results for all of the furnace temperature, wafer temperature, and heater power indicated that temperature control by the actual machine could be simulated with high accuracy. This verification showed that the analysis device according to the present embodiment is capable of executing a simulation related to a temperature state in the substrate processing apparatus with high accuracy.

### <Effects of Embodiment>

The analysis device according to the present embodiment generates disturbance that indicates a temperature change in the substrate processing apparatus according to the process parameters, and adjusts the temperature calculated by a simulation model based on the disturbance. Accordingly, with the analysis device according to the present embodiment, the accuracy of simulation results related to a temperature state in the substrate processing apparatus is improved.

A conventional mathematical model used for a simulation related to temperature control is, for example, for simulating temperature control inside the processing container closed with the lid body of the vertical thermal processing apparatus, and was unable to trace an operation with a significant temperature change inside the processing container when the lid body is opened during loading. The analysis device according to the present embodiment is capable of simulating such a significant temperature change with high accuracy since disturbance that indicates a temperature change detected by the temperature sensor of the substrate processing apparatus is added to the temperature calculated by the simulation model.

The analysis device according to the present embodiment is capable of representing disturbance with a small number of parameters since it approximates the disturbance as a first-order delay curve. For example, disturbance parameters of the furnace temperature include only the time when the furnace temperature begins to decrease, the time when the furnace temperature decrease ends, and the temperature when the furnace temperature decrease ends. Further, for example, disturbance parameters of the wafer temperature include only the time when the wafer temperature i begins to increase and the time constant related to the wafer temperature increase.

The analysis device according to the present embodiment analyzes and stores disturbance parameters for combinations of set temperatures and loading speeds inside the processing container. With this configuration, even when the set temperature or loading speed included in the process parameters differs from the completely analyzed disturbance parameter, the corresponding disturbance parameter may be calculated by interpolation. Accordingly, with the analysis device according to the present embodiment, it is possible to simulate temperature control with high accuracy even for process parameters for which a temperature change has not been analyzed with an actual machine.

The substrate processing apparatus that executes a process including the information processing method of the present disclosure is not limited to a thermal processing film forming apparatus. The substrate processing apparatus may be applied to any type of apparatuses such as atomic layer deposition (ALD), capacitively coupled plasma (CCP), inductively coupled plasma (ICP), radial line slot antenna (RLSA), electron cyclotron resonance plasma (ECR), and helicon wave plasma (HWP) apparatuses.

Further, the substrate processing apparatus of the present disclosure may be applied to all apparatuses regardless of whether a plasma is used as long as they perform a predetermined processing (e.g., film formation, etching, etc.) on a substrate. Further, the substrate processing apparatus of the present disclosure may be applied to all of a single wafer type apparatus that processes one substrate at a time, a batch type apparatus that processes multiple substrates in a batch, and a semi-batch type apparatus that processes fewer substrates than in the batch type apparatus in a batch.

According to one aspect, it is possible to improve the accuracy of simulation results related to the temperature state in a substrate processing apparatus.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. An information processing apparatus comprising:
a memory; and
a processor coupled to the memory and configured to:
execute a simulation using a simulation model of a substrate processing apparatus according to a process parameter;
generate a disturbance indicating a temperature change in the substrate processing apparatus according to the process parameter; and
adjust a temperature calculated by the simulation model based on the disturbance.

2. The information processing apparatus according to claim 1, wherein the substrate processing apparatus is a thermal processing apparatus that performs a thermal processing on a plurality of substrates that is held vertically at a predetermined interval by a substrate holder disposed inside the processing container, and
the disturbance indicates the temperature change when the substrate holder is loaded into the processing container.

3. The information processing apparatus according to claim 2, wherein the disturbance is generated based on a parameter set for a set temperature inside the processing container and a loading speed of the substrate holder into the processing container, both the set temperature and the loading speed being included in the process parameter.

4. The information processing apparatus according to claim 3, wherein the processor is configured to generate the parameter by interpolation when no parameter is set for the set temperature and the loading speed included in the process parameter.

5. The information processing apparatus according to claim 3, wherein the disturbance indicates a change in a temperature inside the processing container, and
the parameter includes a start time when the temperature inside the processing container begins to decrease, an end time when a decrease in the temperature inside the processing container ends, and a minimum temperature when the decrease in the temperature inside the processing container ends.

6. The information processing apparatus according to claim 5, wherein the processor is configured to generate, as the disturbance, a first first-order delay curve determined by the start time and the minimum temperature and a second first-order delay curve determined by the end time and the minimum temperature.

7. The information processing apparatus according to claim 3, wherein the disturbance indicates a change in a temperature of the substrate, and
the parameter includes a start time when the temperature of the substrate begins to increase, and a time constant related to an increase in the temperature of the substrate.

8. The information processing apparatus according to claim 7, wherein the processor is configured to generate, as the disturbance, a first-order delay curve determined by the start time and the time constant.

9. The information processing apparatus according to claim 2, wherein the processor is configured to generate two or more disturbances each indicating the temperature change at each position for two or more positions at different heights inside the processing container.

10. An information processing method that causes a computer to execute a procedure comprising:
executing a simulation using a simulation model of a substrate processing apparatus according to a process parameter;
generating a disturbance indicating a temperature change in the substrate processing apparatus according to the process parameter; and
adjusting a temperature calculated by the simulation model based on the disturbance.

11. A non-transitory computer readable storage medium having stored therein a program that causes a computer to execute a procedure including:
executing a simulation using a simulation model of a substrate processing apparatus according to a process parameter;
generating a disturbance indicating a temperature change in the substrate processing apparatus according to the process parameter; and
adjusting a temperature calculated by the simulation model based on the disturbance.
